(19) United States
(12) Patent Application Publication
(10) Pub. No.: US 2004/0024569 A1
(43) Pub. Date: Feb. 5, 2004

(54) Performance proficiency evaluation method and system

(76) Inventor: Philip Lee Camillo, Saugatuck, MI (US)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(21) Appl. No.: 10/631,584

(22) Filed: Jul. 31, 2003

Related U.S. Application Data
(60) Provisional application No. 60/400,805, filed on Aug. 2, 2002.

(51) Int. Cl. G06F 11/30; G06F 15/00; G21C 17/00

(52) U.S. Cl. 702/182

(57) ABSTRACT

A system and method for evaluating any level of performance of an individual in any job level of any job position is provided using a computer-based technology, including a file server adapted to be in communication with at least one remote station and at least one storage medium; a first database of information stored on the storage medium and containing performance skill standards directly related to the job level of the job position; a database of information stored on the storage medium and containing a bibliography of reference materials concerning the job level of the job position. Also resident on either the remote station or the file server is a software program for providing access to the data in the databases and managing it in a manner for assessing the individuals level of proficiency in the performance skill standards for the job level of the job position, and creating a bibliography output containing a list of reference materials based upon the individual's assessment and for use by the individual to improve his or her level of performance about the job level of the job position.

### CROSS REFERENCE TO RELATED APPLICATIONS

This application claims priority of U.S. provisional patent application Serial No. 60/400,805, filed on Aug. 2, 2002.

### BACKGROUND OF THE INVENTION

1. Field of the Invention

This invention relates generally to a method and system for evaluating any number of levels of performance of a person in one or more skill areas using one or more evaluation methods as determined by the evaluator. In particular, the invention relates to a software related self or other based assessment method and system for determining the competency of an individual concerning one or more skill levels, determining areas needing performance improvement, then prescribing available resource materials to assist the individual to learn, and then re-assessing the individual's improvement, using possibly a different self or other based assessment method or system.

2. Description of the Related Art

Methods for assessing a person's competency level in a given skill area have not changed substantially throughout history. An individual learns through teaching or actual experience, and is then assessed in any one of a number of ways as to what has been learned. Learning continues as the person advances to a new performance level. Traditionally these testing methods involved a face-to-face student/teacher relationship where the learning plans were sometimes customized to suit the particular individual's needs. Indeed, in today's world, many professions and educational institutions have required that a member of the profession demonstrate their competency in an area by requiring the individual to sit for an examination. Businesses have been founded specifically on the service of teaching, testing, and developing learning programs to improve the individual's level of performance. However, in today's world, industries are becoming larger, and demands on time are becoming greater. What results is that individuals do not maintain their proficiency or level of competency/understanding in one or more subject areas.

With the advent of the Internet, traditional methods of teaching have been made available online. Although the substance of the information has been made available, the competency of the individual is rarely tested. Although information may be re-visited during the continuing education process, there is no guarantee the information is retained and performance has been improved, i.e. skill levels have increased. The method of the instant invention satisfies all of the shortcomings of the prior continuing education and professional proficiency evaluations.

In short, the method and apparatus of the invention uses a computer-based technology to assess an individual's level of performance predetermined by the organization, then dynamically creates a “custom, individualized” learning plan based upon the assessment to help the individual improve in the area assessed, and creates a credible accounting to verify the individual has indeed satisfied an established standard of education or training in a subject area. More specifically the invention includes a software tool that stores information about a user's competency on a set of skills, and manages the individual's performance through a plurality of levels that can be used to certify/verify the individual's knowledge, performance, application, and best practices on the selected skill set. The invention is engineered to cater to individual learning styles to demonstrate an individual's competency and/or proficiency in a subject area.

### SUMMARY OF THE INVENTION

According to one form of the invention, the method is based upon a software program written in any one of a number of different languages to achieve the same goals determining the performance level of an individual, defining the skill gaps for the individual, providing a prescribed learning plan based on the person's evaluation, as well as a system for educating the individual and assessing the resulting performance level.

Accordingly, it is an object of the invention to provide a computer software program that manages the assessment of an individuals level of performance in any level of a job position, customizing a learning plan for the individual or permitting the user to define their own learning plan, and to improve the performance level in the subject area.

According to another form of the invention, the method also provides for teacher/student interaction via a computer network where learning plans are assigned by the instructor for the student to complete and use as a learning tool to improve his or her performance level.

It is another object of the invention to offer the student the ability to learn at their own pace using either a self developed learning plan, a third party designed learning plan, or a prescribed learning plan developed by the system to become more proficient.

Another aspect of the invention provides a system for evaluating any level of performance for an individual in a predetermined job level of a job position, by including a file server adapted to be in communication with at least one remote, client station and at least one storage medium; a first database of information stored on the storage medium containing performance skill standards concerning the job level of the job position; a second database of information stored on the storage medium containing a bibliography of reference materials concerning the job level of the job position; and a software program on one of the remote client stations and the storage medium for providing access to data in the first and second databases to assess the individual's level of performance concerning a set of skill standards for the job level of the job position, and creating a prescribed learning plan containing a bibliography of reference materials compiled from the first bibliography for use by the individual based upon the determination of the individual's level of performance for the job level of the job position.

Another aspect of the invention further includes using a computer system in communication with the file server and directed by the software program for accessing at least one resource available on the Internet and searching that resource for learning tools for the user based upon the individual's assessment. In addition it is contemplated additional databases of information may be stored on the remote client station or the storage medium for recording the progress of the individual using the system. Additional modifications could also include search engines, resident either on the system, or linked through interactive programs to use key terms as a searching tool to uncover additional resources that may be used by the individual in learning more about the job position skills.

Another form of the invention includes a computer-based job skill evaluation system, comprising a file server accessible through one of a local area network and an internet service provider; a storage medium in communication with said file server; a database residing on the storage medium and containing a predetermined set of job skills relating to at least one job level of a job position; a remote client computer system adapted to be in communication with the file server through the local area network or internet service provider; a computer program resident on either the file server or remote client computer system for assessing the user's level of performance regarding predetermined job skills, and automatically preparing a prescribed learning plan including a bibliography of reference materials based upon the assessment of the user's performance.

Another form of the invention includes a method for assessing the competency level for at least one individual for a predetermined job level of a job position, comprising the steps of establishing a set of skills required by the individual for the job position; establishing one or more performance levels for each of the skills in the skill set; assessing the individual's level of performance of the skill sets; and prescribing a list of resources based upon the results of the assessment for use by the individual to increase the level of skill.

Another form of the method may include the step of establishing a set of skills required by the individual to include a portfolio of self-established skill sets and skill sets defined by third parties. The invention may also include a step of assessing the individual's level of proficiency for the skill sets by submitting artifacts (electronic files) evidencing knowledge, comprehension, application, and best practices of the skill sets. The step of defining a learning plan may also include one of selecting educational material from a list of computer selected reference materials, having educational materials assigned by a third party, and selecting educational materials from a list prescribed by the invention. Based upon the user's level of achievement, a third party such as a coach or mentor may review the artifacts submitted by the individual in response to the learning plan to determine whether the individual has gained the knowledge contained within the learning plan.

According to one form of the method mentioned above, one goal is to provide a method for documenting electronically the progress of one or more users following the method and submitting secure reports as evidence of their completion of the competency evaluation. The method may further include the step of establishing corresponding job goals of the individual to the performance levels. In addition, the method may also contemplate defining one or more learning activities for each level of a particular skill. Furthermore the method may be carried out using a computer software system for facilitating interaction between the individual and teacher or coach.

In another form of the invention a method is provided for managing the proficiency of an employee in a predetermined position by defining at least one performance criterion for the position; defining at least one level of proficiency for the one performance criterion; assessing the employee's knowledge, comprehension, application and mastery of the performance criterion; compiling an prescribed list of resources for each assessment of the employee's performance of the standards for use by the employee to improve his or her level of proficiency for the criterion; and generating documentation confirming the employee's level of proficiency for the performance criterion. This method may be carried out by the employee using an Internet-based computer program for assessing his or her level of the performance criterion. In another form, the method may associate a job goal with the level of proficiency. It is also contemplated the method could be adapted to include the step of associating at least one learning activity with each performance criterion at each level of proficiency. Furthermore the method may adopt performance criteria for a position by incorporating criteria established by educational institutions and/or governmental agencies and departments.

The advantages provided by the invention include efficiencies in terms of time which translate directly into costs. Moreover, the invention was engineered to cater to individualized and personalized learning styles, so that the individuals could complete the assessment on their own schedules. Another advantage of the invention is that it provides a universally applicable method for evaluating a person's ability to fulfill the obligations of a job position, and compare proverbial apples to apples rather than relying upon subjective evaluation elements. Additionally, and perhaps most importantly, the invention provides a multi-prong learning plan for the individual including self determined learning plans, assigned learning plans created by teachers and coaches, and automatically prescribed resources produced by the system that the user may access through any one of a number of different routes, including online, to quickly and inexpensively improve his or her skill gaps in a fraction of the time. Demands on an individual's time by the employer have become such that it is inconvenient and inefficient for the user to spend excessive time in continuing education classes. Moreover, rarely is there a procedure in place at these events that really tests the attendee's level of performance of the standards or lessons presented. Here, the individual is free to carryout the evaluation on their own schedule, and quickly have the resources at their fingertips to complete the learning and performance improvement process. Moreover, the user can quickly and easily re-take or improve his or her performance when obtaining initial certification or re-certification.

### BRIEF DESCRIPTION OF THE DRAWING FIGURES

FIG. 1 is a general block diagram of the most rudimentary components comprising the invention;

FIG. 2 is a schematic block diagram of one embodiment of one of the components comprising the invention; and

FIG. 3 is a schematic block diagram of another embodiment of the invention.

### DETAILED DESCRIPTION OF THE DIFFERENT EMBODIMENTS

For purposes of the following description, the terms and derivatives used herein shall have their plain and ordinary meaning unless specifically defined herein. However it is to be understood that the invention may assume various alternative embodiments or use related technology to obtain the same results except where expressly specified to the contrary. It is also to be understood that the specific method steps and system components illustrated in the attached drawings, and described in the following specification, are simply exemplary embodiments of the invention defined in the appended claims. Specific dimensions or ranges and other characteristics of the embodiments disclosed herein are not to be considered as limiting, unless the claims expressly state otherwise.

The instant invention is a computer-based method and system engineered to cater to individualized and personalized learning styles, and primarily intended to assess the level of performance of one or more individuals in at least one skill competency area. Based upon the assessment, the method and system provides the user with a custom-tailored bibliography list of learning resources from which the user can design a learning plan to improve his or her depth of knowledge on the particular subject being assessed. In addition, the invention documents the progress of the user in achieving that goal for later certification and verification.

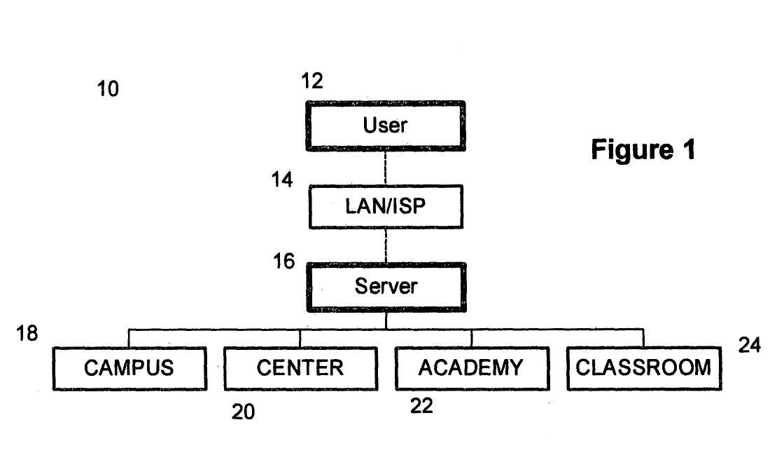

FIG. 1 is a block diagram conceptually illustrating the inventive method and system referenced by numeral 10. The invention uses a computer-based software program accessible over a network, such as the Internet, local area network, or an Intranet, for assessing the proficiency of an individual with respect to predefined job position standards. From the results of the assessment, the software and system compile a customized catalog of learning materials concerning subjects the individual performed below an established standard, so the individual select prescribed materials for inclusion in the prescribed learning plan. As shown in the figure, the system 10 interacts with at least one remote client station 12 that is in communication through one of a local area network or an internet service provider or other communication intermediary 14 to access the data stored on a file server 16. Of course the natural extension of this concept is to have multiple remote client stations 12 access the system 10 at any one time. The remote stations 12 may be personal computers such as desk tops or laptops, or a plurality of workstations interconnected together through a devoted file server system.

The system 10 comprised of the file server 16 shown in FIG. 1 includes a plurality of separate modules and storage media working in combination to provide specific functions. For example, these various functions or components may include a virtual campus 18, a virtual center 20, a virtual academy 22, and a virtual classroom 24. The virtual campus 18 may be the system for maintaining the electronic personal profile information for each user as well the progress records and notes for each user. The virtual campus 18 may also retain records of the activities or “learning plans” selected by the user, assigned by a teacher or collaborator, or prescribed by the invention. The virtual center 20 may provide a place where the instructor and learner may interact. This module may also include information on the faculty working with the user. Library resources and the like may also be stored in the virtual center 20 along with other collaboration tools. It is contemplated the system 10 will also provide a unique virtual academy 22 where standards for different job positions are stored, performance level assessment records are stored, prescriptive learning plan catalogs are available, and learning tools are created based upon the user's assessment results. Lastly, but not least, the virtual classroom 24 offers on-line learning plans delivered through the virtual campus and center.

The system and method associated therewith provide many benefits over prior systems including cost efficiencies, the ability to make user's accountable for their learning, a documentation system, a learning community accessible virtually anywhere throughout the world where a computer connection exists, individualized learning plans, and a unique learning system to take learners from novices to masters of the subject.

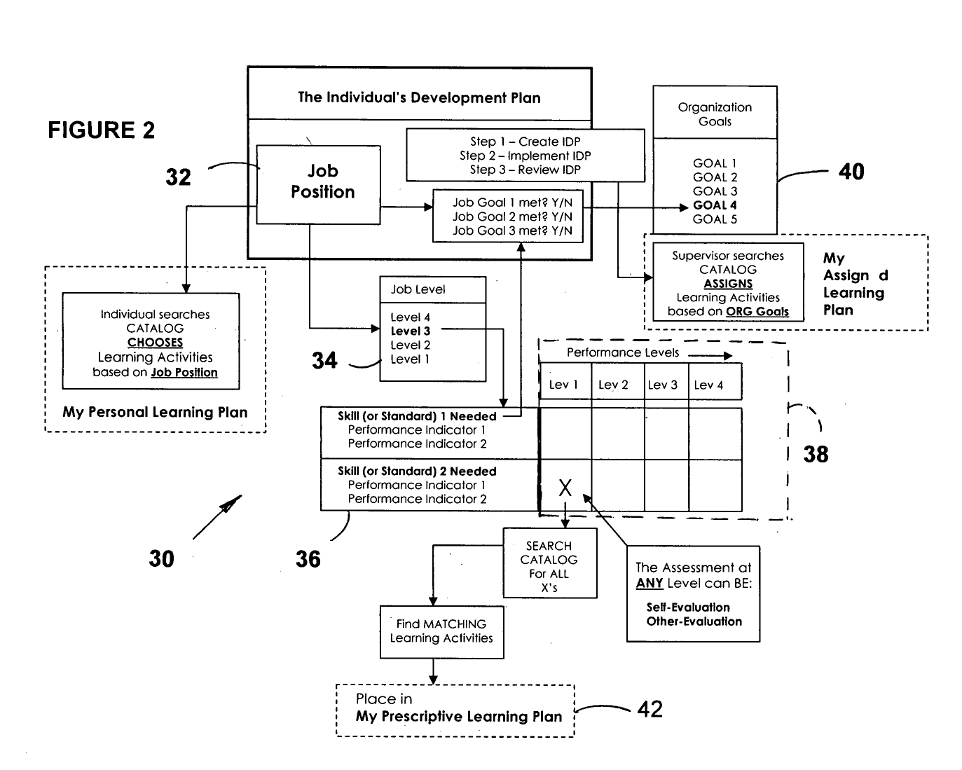

FIG. 2 is a schematic diagram 30 generally illustrating one embodiment of the relationships between the different components of the system, and how information is managed. In particular, this Figure provides a visual image or depiction of how the software and data in the system are physically associated. However, one of ordinary skill in the art of computer programming would realize the information or data represented by the different boxes shown in FIG. 2 are in actually stored in data arrays on the storage media. That aside, the logical relationship between the method and system are apparent in this figure.

It is contemplated that certain job positions will be described in a manner where specific criteria or skill sets are needed to adequately perform the duties of the position. These skill sets are used as a basis for evaluating persons desiring to enter or advance in the ranks of the position. The data describing the job position may be stored on a storage medium to form a database that may be altered, amended or supplemented from time to time by the administrator as necessary. The job position database identified generally by box 32 may also be associated with career paths as well as certificates of accomplishment or other levels of achievement stored in a separate or subset database identified by reference numeral 34. For example, if the job position was a professional auto mechanic, the levels could represent rank ranging from novice, apprentice, journeyman, and the like or other labels of rank. Although four levels of rank are illustrated in the drawing, the actual number of levels may be different, depending in substantial part by the authority setting the standards.

Each of the job positions levels or ranks of achievement set forth database 34 preferably would be associated with a standards database identified by reference numeral 36. As shown in FIG. 2, the standards database 36 could include a plurality of skill sets associated with particularly defined performance indicators. The skill sets contained in database 36 may be defined by a professional organization or industry-governing organization for each job level. For example, skills for teachers at a certain career level may be defined by the school board. These requirements may then become the standards of proficiency each teacher at that career level must attain in order to advance in his or her career. Again, although the example shown in FIG. 2 depicts two skills or standards, the actual number will vary according to the job position or sanctioning authority responsible for promulgating the standards.

In the instant invention, the standards database is preferably associated with a unique assessment module and database generally identified by reference numeral 38 that provides the assessment or evaluation of the user to verify the required level of skill for a job level has been satisfied. The assessment module and database 38 is where the user interacts with the system 10 for the purposes of testing the user's knowledge, comprehension, application and ultimately the mastery or “best practices” of the skill sets required for the given job position. Moreover, the assessment module determines electronically based upon the assessment methods used performance level standards where the user is deficient or weak, and autonomously compiles a catalog of educational resources for the user to select and place in a prescribed learning plan for improving performance in those skills. For example, as shown in FIG. 2, Skill No. 1 shown in database 36 requires the user to understand two performance indicators at four different levels of proficiency identified by the row of boxed fields appearing in module 38 under the headings “Level 1” through “Level 4”. In order for a user to advance from Level 1 to Level 2 for Skill 1, the user must first demonstrate they have shown to be in possession of the skills listed in database 36 for Level 1 or the preceding level. It is contemplated that each level utilizes a different method of documenting proficiency in the skill set at each level of performance. For example, it is contemplated in one embodiment of the inventive the user may document they are in possession of the skills at Performance Level 1 through a self-assessment, or by taking a prescribed written exam. In the same example, Performance Level 2 may require the involvement of another person such as a supervisor or teacher. Here the second party may make the assessment on the user's comprehension of the skill sets using hypothetical fact scenarios or controls through written examination as well as observation. At Performance Level 3, the user may need to demonstrate to a coach or mentor that he or she can apply the requisite knowledge to different factual or hypothetical scenarios. Lastly but not least, Performance Level 4 may be used to demonstrate the user has obtained the highest level of proficiency as expressed by the opinion of his or her peers that certain practices or theories are credible or should be adopted. In essence, the sanctioning authority promulgating the standards may dictate anyone of a number of different assessment methods as being acceptable and are anticipated to be different for different job positions.

As briefly mentioned about the invention, and particularly module 38 identifies when a user does not attain the requisite level of skill required for a given standard. For example, when a user accesses the assessment module at a given job level, and is evaluated either through testing or other form of assessment, the system utilizes a predetermined assessment key to determine whether the particular standard or skill is satisfied. If the skill is not satisfied (skill gap), a code or marker is used in the database to indicate the particular requirement has not been satisfied. From this, the module 38 implements a software routine that queries a predetermined resource database to identify learning materials or other resources related to the specific skill gap. These materials are compiled in a virtual catalog for easy reference by the user. From the virtual catalog the user may select all or a subset of the materials for inclusion in what has been referred to above as the prescribed learning plan. This information is then used to acquire the skills necessary to fill the gap. The details of the procedure in the method will be described in greater detail below, and the reader is referred to that section.

After digestion of some or all of the information provided by the catalog of materials produced above, the user is free to re-take the assessment until all of the skills are demonstrated for a particular performance level. Another important aspect of the invention is that the invention documents the entire process for review by the user's superiors or instructors, and for later reference by the user. The user's superiors and/or instructors may also use the information to show compliance with any particular skill level. For example, the superiors and administrators could access the information remotely to verify that indeed the user has obtained the skills necessary to fulfill the job position, rather than relying entirely upon the user's representations they are in possession of the skills. For example, with respect to performance level 1 of the second skill required by the standard in block 36 of FIG. 2, the user may select self-certification or another form of assessment such as a written exam, an oral exam, or other form of evaluation to demonstrate the assimilation of the learning materials. This same procedure may be applied with the other levels of performance as dictated by the sanctioning authority. To the best of the inventor's knowledge, no prior performance management system, proficiency assessment, or learning management tool provides a catalog of learning tools based upon skill gaps identified through an assessment nor have others conducted the assessment process through the plurality of performance levels as in the present invention.

The invention also contemplates that a user's superior or administrator may monitor and review the history of individual employees in satisfying the established standards as represented generally by block 40. The information on one or more users may be formatted into reports to be reviewed by more senior officers or staff. This may be accomplished by the administrator or other authorized person accessing the database and retrieving the user's records stored in the profile module. The reports could be used as a basis for conducting audits or an accounting for compliance. Indeed, should the administrator or sponsoring organization find the assessment is flawed, or requires up-dating, the administrator may have the authority to add, delete, or alter any of the standards.

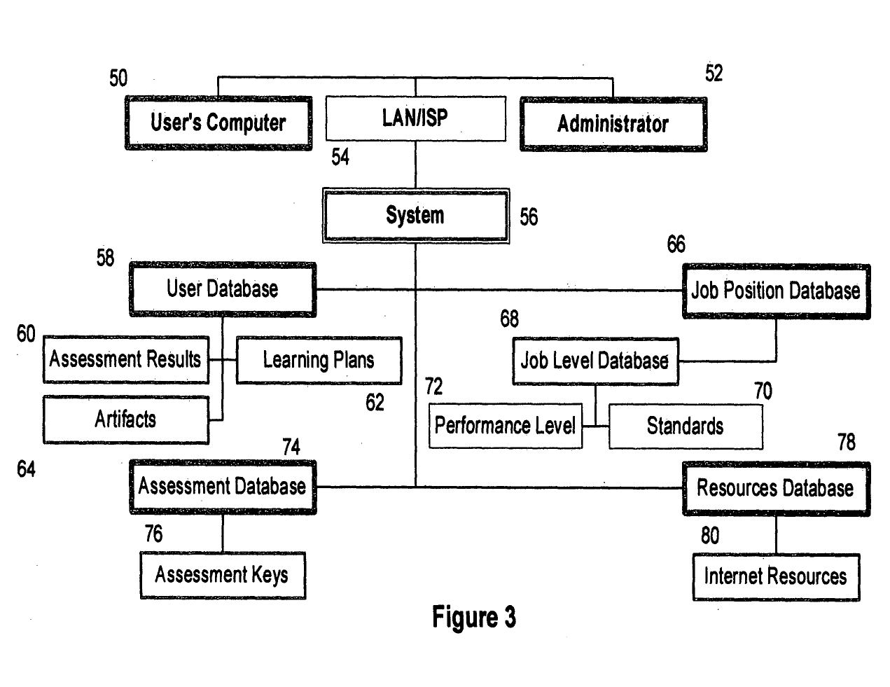

The reader is referred to FIG. 3 where the method of the invention 10 is illustrated in schematic form. At the top of the diagram are two types of user's: the user undergoing assessment in block 50 and the user's Administrator or supervisor in block 52. It is contemplated that both users implement the method and access the invention using computers. Indeed, the system may be comprised of anyone of a number of different computer systems. For example, block 54 below user 50 and Administrator 52 may represent a local area network or an Internet Service Provider 54 for providing access to the system 10. Additionally, block 54 may also represent the cpu for stand alone systems. It is contemplated that those of ordinary skill in the art would include at least one file server 56 for storing, accessing, and manipulating a plurality of database tables or files representing the information used in completing the method. More specifically, it is contemplated the system 56 may include a user database identified by reference numeral 58 for storing details about the various users and/or Administrators including user names, passwords, employer, and current job position as well as job goals. For each user, the user database 58 may be associated with or have sub-files storing information particular to each user, including but not limited to, assessment results 60, learning plans 62, and artifacts 64 generated by the user to evidence he or she is in possession of certain job skills. At the end of each session, this database would track and store the history of that session so the user 30 may log-on at a later date, and complete the particular assessment or lesson plan.

Also associated with the system 56 may be a job position database 66. In this embodiment, it is contemplated the job position database 66 may constitute a read-only file for the user as it may contain the job position and job level database 68, the job level skill standards data 70, and the different performance level data 72. The data contained therein may be amended, updated, or the like by the System Administrator in response to industry standards, legislation, or other driving forces for establishing the standards.

The system 56 would also include an assessment database 74 to provide the user with predefined criteria for making an assessment for a particular job position and level. Also associated with this database would be the assessment answer key 76 needed to make the comparison between the user's responses against the promulgated answers. As in the previous paragraph, it is contemplated assessment key 76 would be a read-only file unless access is granted to the Administrator or other party having authority to make alterations or save changes. This file may also store the results of artifact reviews submitted by teachers, coaches, and mentors resulting from the user's demonstration of certain skills. Here the particular teacher/coach/mentor may provide the input and comments on the user's work that may also be recorded in the user's database 58 described above.

Once the assessment has been completed, an important aspect of the invention and system is the step of creating a catalog of learning tools and other information selected from a larger resource database 78 based upon the gaps in the user's skill assessment. The user 50 selects one or more of the identified materials for inclusion in the prescribed learning plan for later reference to improve those gaps in skill that were determined by the assessment to fall below the standard. It is contemplated this resource database 78 may comprise a predetermined bibliography of publications, articles, treatises, outlines, artifacts of others, and other works indexed by key words, from which the user may select to add to his or her prescribed learning plan stored in database 42. The resource database 78 may also interact with or possess a search engine ability to automatically search for other resources such as on the Internet by creating word searches using words taken from the skill sets the user failed to satisfy. Moreover, it is contemplated the resource database 78 may also contain links to other websites and service providers that could provide information pertinent to the particular skill, or provide its own set of learning tools and resources to aid the user to ultimately master the skill. The results of the resources identified by the word searches may be compiled and stored as a separate file in the user's database for easy reference and historical preservation.

As the user progresses through the method, management may monitor the user's status, progress, and strong or weak skills to best utilize the individual's talents. In addition, the method of the invention makes it possible for the administrator or manager to electronically alter one or more of the standards by way of updates. It is important to note the standards, and the user's compliance with those standards, may be used as a one basis for advancing that employee—that is, to attain a job goal. In addition, adherence by the employees to these standards could also serve to advance and achieve the organization's goals.

As mentioned above, it is contemplated the method of the invention be carried out through the use of computers running one or more software program routines. For example, conventional desktop or laptop computers may be used by the users to access the System 10 either through a local area network or alternatively through an Internet service provider. Additionally, the System 10 may be one or more remote computer systems connected through file servers for retaining the computer software and storage media. The executable computer software may be resident on either the user's computer or the remote file server, but preferably on the latter since it can be protected using different levels of security and to keep the number of copies to a minimum. Relational databases may be resident on the file server(s) as one method for carrying out the invention to store and retrieve specific performance criteria as well as the progress records for each user. The particular program or database is not particularly important since it is believed the method could be programmed using anyone of a number of different programming languages. Moreover, it is anticipated the method may be made available to the user over the Internet so users could access the System from virtually anywhere in the world having an Internet portal.

In one particular embodiment, a file server may be adapted to be in communication with at least one remote client station such as a computer at the user's home. The file server and storage medium would also be accessible either through a local area network or through an Internet or Intranet portal for convenience. The file server and storage media would preferably be conventional equipment with the ability to expand both in terms of computing capacity and memory capacity. The storage media would be sufficient to retain numerous data files including a first database of information containing performance skill standards for the job positions, as well as a predetermined catalog of references materials related to the job position. As briefly discussed above, it is preferred the software program for carrying out the method be resident on the file server and provide access to data on the storage media to determine the individual's level of performance concerning specified skill standards for the predetermined job position. The same software may assist in creating a second catalog of reference materials from the first catalog for use by the individual based upon the determination of the individual's gap skills.

In another embodiment of the invention, a search engine may be resident in or in communication with the file server and directed by the software for accessing resources on the file server resource database, or available online over the Internet. The same software may be more than capable of searching those resources for learning tools based upon the individual's level of performance of the job skills. The search engine need not be resident on the system, but may be accessed using a computer software routine to direct the inquiry. Alternatively, depending upon the software architecture, the search engine could be incorporated in the software package. This same software program containing or accessing the search engine would store a secure file on one of the computers recording the progress of the individual's learning.

In operation, the user may login using a unique user name and password. The user may be keyed to one or more job positions, either through self selection, or by a another party such as the administrator prior to the user accessing the system. Based upon the job level, the system then accesses the relevant database records to determine if the user is new to the system, or in the middle of working toward a particular job goal. As mentioned above, this information may be stored in a database associated with the user. If the user is new to the system 56, the system may automatically assume the user is entering at a novice or entry level position, and assign the standards appropriate for that level. However, if the user has been certified under another system, provision may be made for management to begin the user at a higher level.

The method and system were designed to accommodate user's varying schedules since most may be already working in a profession, and the assessment is a tool to recertify the user in the current position. Should the user pause in the middle of an assessment, the System may mark and save the position so the user may return at a later data and begin where they left off. In addition, when particular performance criteria have been shown to be satisfied, the computer software also marks satisfaction so the user knows his or her progress after a hiatus.

One embodiment of the software may utilize a windows-based software system created in HTML or similar language for ease in navigating between the various tasks or modules. For example, after logging into the system, a user may be greeted with a welcome screen providing general announcements about upcoming events, changes to the system, or the like. The welcome screen may also contain a menu containing links to other programs or resource materials related to the method. For the purposes of example only, the system software may also include a link to a catalog the user may search to find learning plan groups, lesson plans, activity types, or virtually any resource the administrator believes is appropriate. The menu may also contain a link to the user's portfolio that contains selected goals for the calendar year or other period of time, and a personal portfolio setting forth the areas of personal development, and other relevant assessment program information.

Closely associated with the personal portfolio link may be a mentor portfolio link. Under this section, the user may be able to identify standards associated with the user's goals as well as create action plans for attaining the prescribed goals. The user may also upload programs or materials prescribed by the teacher/coach/mentor to create artifacts evidencing application of the job skills. The same mentor file may also contain contact information for the one or more teachers/coaches/mentors working with the user throughout the assessment program.

It is contemplated the menu would contain a second link for learning plans. The learning plans may be on-line course work, or an online meeting of class members of a program chaired by one of the coaches or teachers. A subset to this menu may be the personal, assigned, and prescribed learning plans or activities established by the user, coach or teacher, or system, respectively. As each of the titles connote, the personal learning plan or activities are selected by the user, while the assigned learning materials are assigned by the teacher/coach/mentor or administrator. The prescribed learning plan comprises learning materials selected by the user from the compiled list of references based upon the user's skill gaps identified from the assessment. Together these three learning plans provide the user the with necessary tools to master a selected performance skill or standard.

The method and system also provides for the generation of reports on predetermined topics. For example, it is contemplated that reports on the progress of the user's learning, as well as the completed learning may be generated either by the user or the user's supervisor. Moreover, the reports generated by the user's supervisor could contain information not disclosed on the user's reports including time to complete each level of evaluation, and to complete artifacts, and other information that may be used to determine the user's expectation of performance in the job position. Last but not least, the reports could be exported in a predetermined format and containing predetermined information to verify certain information about an organization's qualifications. Other reports contemplated to be of use in the invention and system include a development plan report where the user's profile, hours earned, goal statements, completed learning, and personal portfolio entries may be gathered and displayed for easy reference.

Another resource available as a link may include faculty information that can be edited by administrators, teachers, coaches, and mentors as part of the record of the user. Library links could also be recorded as part of the system for the user to find in one location the complete list of reference materials that were downloaded or otherwise made available over the system for the user to reference. Other information under this general resource heading could include links to the user's lesson plans relating to a particular topic for use later in the course of carryout the responsibilities of the job position, or earlier during the assessment stage.

Other services provided under a general resource tab or link may be links to chat rooms or bulletin boards where the user may collaborate with peers about interesting topics, or to ask questions of his or her peers. Additionally, given the notion it is contemplated this method and system will be remotely accessed, the methods for finding help on certain topics would be convenient. Here, the user could find the answers to frequently asked questions as well as live support should the need arise.

This method and system for assessing an individual's depth of knowledge and know-how for a given topic were described in certain instances with specificity, particularly where examples were provided. Other aspects of the invention were described very generally as it is believed that a computer programmer of ordinary skill in the art would possess the know how to write the code to carryout the prescribed steps of the method once outlined. Likewise, this same individual would know, based upon reading this specification, what hardware would be required to store the software program, as well as store the data concerning the job positions, job levels, and other information accessed by the System. For this reason, details of these features were not discussed herein. Other aspects of the invention are not critical to its performance. These include the specifics on the software language. It is also contemplated the invention may be used in a wide range of professions ranging from auto mechanics to medicine. A prototype of the invention has been designed specifically for application to the education industry and has received wide spread acceptance.

The above description is considered that of the preferred embodiments only. Modifications of the invention will occur to those skilled in the art and those who make or use the invention. Therefore, it is understood that the embodiments shown in the drawings and the examples set forth herein are described merely for illustrative purposes and not intended to limit the scope of the invention as interpreted according to the principles of patent law, including the doctrine of equivalents.

### I claim as my invention:

1. A system for evaluating a level of performance for an individual in a predetermined job level of a job position, comprising:
a file server adapted to be in communication with at least one remote station and at least one storage medium;
a first database of information stored on said at least one storage medium containing performance skills standards concerning the predetermined job level of the job position;
a second database of information stored on said at least one storage medium containing a bibliography of reference materials concerning the predetermined job level of the job position; and
a software program on one of said at least one remote station and at least one storage medium for providing access to data in said first and second databases to determine the individual's level of performance concerning the skill level for the predetermined job level of the job position, and creating a second bibliography of reference materials from said first bibliography for use by the individual based upon the determination of the individual's level of performance about the predetermined job level of the job position.

2. The system as defined in claim 1, further comprising a computer system in communication with said file server and directed by said software program for accessing at least one resource available on the Internet and searching said at least one resource for learning tools based upon the individual's level of performance concerning the skill level for the predetermined job level of the job position.

3. The system as defined in claim 2, further comprising a third database of information stored on one of said remote station and said at least one storage medium for recording the progress of the individual's level of performance concerning the skill level for the predetermined job level of the job position.

4. The system as defined in claim 3, further comprising a search engine accessed by said file server for using key terms to search the Internet for additional resources to be used by the individual in learning more about the job level of the job position.

5. A computer-based job skill evaluation system, comprising:
a file server accessible through one of a local area network and an internet service provider;
a storage medium in communication with said file server;
a database residing on said storage medium containing a predetermined set of job skills relating to at least one job level of one job position;
a remote computer system adapted to be in communication with said file server through one of said local area network and said internet service provider; and
a computer program resident on one of said file server and said remote computer system for testing a user's level of performance about the job level of the job position, and automatically preparing a bibliography display of reference materials for reference by the user based upon the assessment of the user's performance level.

6. A method for assessing the competency level for at least one individual at a predetermined job level of the job position, comprising the steps of:
defining a set of skills required by the individual in the job level of the job position;
creating one or more performance levels for each of the skills in the skill set;
assessing the individual's knowledge of the skill sets at each of the performance levels; and
creating a display of resources for use by the individual in response to the results of the individual's assessment.

7. The method as defined in claim 6, wherein the step of establishing a set of skills required by the individual includes a portfolio of self-established skill sets and skill sets defined by third parties.

8. The method as defined in claim 6, wherein the step of assessing the individual's knowledge of the skill sets at each of the performance levels comprises submitting artifacts evidencing the individual's level of skill.

9. The method as defined in claim 6, wherein the step of defining a learning plan comprises one of selecting educational material from a list of computer selected reference materials and completing educational materials prescribed by a third party.

10. The method as defined in claim 6, further comprising the step of having a third party review of artifacts submitted by the individual in response to the learning plan.

11. The method as defined in claim 6, further comprising the steps of documenting electronically the progress of a plurality of individuals and submitting secure reports as evidence of completion of competency evaluation.

12. The method as defined in claim 6, further comprising the step of establishing corresponding job goals of the individual to said performance levels.

13. The method as defined in claim 6, further comprising the step of defining one or more learning activities for each level of a particular skill.

14. The method as defined in claim 6, further comprising the step of providing a computer software system for facilitating interaction between the individual and

15. A method for managing the performance level of an employee in a predetermined job level of a job position, comprising the steps of:
defining at least one performance criterion for said job level of the job position; defining at least one level of proficiency for said at least one performance criterion;
assessing the employee's understanding of said at least one performance criterion for said at least one level of proficiency;
compiling an electronic list of resources for use by the employee to improve the employee's level of proficiency for said performance criteria; and
generating documentation confirming the employee's level of proficiency for said at least one performance criterion.

16. The method as defined in claim 15, further comprising the step of providing an Internet-based computer program to be accessed by the employee for assessing the employee's understanding of said at least one performance criterion for said at least one level of proficiency.

17. The method as defined in claim 15, further comprising the step of associating a job goal with said at least one level of proficiency.

18. The method as defined in claim 15, further including the step of associating at least one learning activity with each performance criterion at each level of proficiency.

19. The method as defined in claim 15, wherein the step of defining at least one performance criterion for said position comprises incorporating criteria established by institutions and/or governmental agencies and departments.

20. The method as defined in claim 15, wherein the step of defining at least one level of proficiency for said at least one performance criterion includes the step of defining a plurality of proficiency levels ranging from novice to expert.
